(19) United States
(12) Patent Application Publication
(10) Pub. No.: US 2009/0044241 A1
(43) Pub. Date: Feb. 12, 2009

(54) BROADCASTING CONTENT PROTECTION/MANAGEMENT SYSTEM

(75) Inventors: Sang Hyun Joo, Daejeon (KR); Bum Suk Choi, Daejeon (KR); Hyun Gon Choo, Busan (KR); Young Bae Byun, Seoul (KR); Je Ho Nam, Seoul (KR); Jin Woo Hong, Daejeon (KR)

Correspondence Address: CANTOR COLBURN, LLP, 20 Church Street, 22nd Floor, Hartford, CT, 06103, US

(73) Assignee: Electronics and Telecommunications Research Institute, Daejeon (KR)

(21) Appl. No.: 11/911,136

(22) PCT Filed: Oct. 12, 2005
(86) PCT No.: PCT/KR05/03406

§ 371 Date: Aug. 19, 2008

(30) Foreign Application Priority Data
Apr. 15, 2005 (KR) 10-2005-0031359

(51) Int. Cl. H04N 7/173; G06F 17/30; G06F 21/24; G06F 15/16; H04L 9/32

(52) U.S. Cl. 725/114; 707/10; 726/1; 709/203; 726/3; 726/28; 707/E17.008; 707/E17.044

(57) ABSTRACT

Provided is a contents protection and management system including: a contents processing server for providing a service subscriber with contents and producing information for protection and management of the content; a DRM tool server for managing tools used in the contents processing server and the subscriber terminal to process the content; and a license server for managing the subscriber's right to the content.

### TECHNICAL FIELD

The present invention relates to a system for protecting and managing digital broadcast contents used in digital or Internet broadcasting.

### BACKGROUND ART

As digital industry develops, the importance of protecting digital contents is increasing, and various digital rights management (DRM) systems have been developed. Contents providers have been employing their own contents protection and management tools, and their reluctance to disclose them has made it difficult to ensure the interoperability of tools used by different contents providers.

In the case of broadcast contents, in order for a subscriber terminal to receive broadcast contents from a plurality of broadcasting companies, he/she needs each broadcasting company's conditional access system (CAS) or DRM. Thus, ensuring interoperability for various CASs or DRMs while minimizing subscriber inconvenience is the issue.

In a recent broadcast contents service, an MPEG-2 stream is used as a contents format, and it has a framework in which interoperability is ensured more or less by downloading a missing tool, which is a function provided by MPEG-2 Intellectual Property Management and Protection Extension (IPMPX). However, broadcasting companies have taken a passive attitude toward disclosing their own CAS or DRM tools, and so there is an urgent need for a technique for guaranteeing interoperability while protecting the tools of the contents provider.

### DISCLOSURE

### Technical Problem

The present invention is directed to a broadcast contents protection and management system that ensures interoperability between various contents service tools.

The present invention is also directed to a broadcast contents protection and management system that provides high security while ensuring interoperability between various contents service tools.

### TECHNICAL SOLUTION

One aspect of the present invention provides a contents protection and management system comprising a contents processing server for providing a service subscriber with contents and producing information for protection and management of the content; a DRM tool server for managing tools used in the contents processing server and the subscriber terminal to process the contents and tools for copyright protection; and a license server for managing the subscriber's right to the content.

### ADVANTAGEOUS EFFECTS

As described above, the broadcast contents protection and management system of the present invention has the following advantages: Firstly, interoperability of various contents service tools of different contents providers can be ensured.

Secondly, the license can be granted by various methods as the broadcast contents protection and management system and the client domain system are implemented together.

Thirdly, since independent servers perform respective operations, responsibility between the servers can be clearly discriminated.

Finally, since independent servers perform respective operations, the broadcast contents protection and management system can be efficiently operated while ensuring high security for the DRM tool.

### DESCRIPTION OF DRAWINGS

FIG. 1 is a schematic illustration of transmission and distribution of broadcast contents in a broadcasting environment;

FIGS. 2A to 2C are schematic diagrams of a broadcast contents protection and management system according to an exemplary embodiment of the present invention;

FIG. 3A is block diagrams of a contents processing server according to an exemplary embodiment of the present invention;

FIG. 3B is block diagrams of a Contents transmission server according to an exemplary embodiment of the present invention;

FIG. 4 is a block diagram of a DRM tool server according to an exemplary embodiment of the present invention;

FIG. 5 is a block diagram of a license server according to an exemplary embodiment of the present invention;

FIG. 6 is a block diagram illustrating a decoding structure of a subscriber terminal according to an exemplary embodiment of the present invention; and

FIG. 7 is a block diagram illustrating an interface structure of the subscriber terminal according to an exemplary embodiment of the present invention.

### DESCRIPTION OF MAJOR SYMBOL IN THE ABOVE FIGURES

20: Contents processing server
22: Contents registration server
24: Contents transmission server
40: DRM tool server
50: License server

### MODE FOR INVENTION

The above and other features and advantages of the present invention will become more apparent to those of ordinary skill in the art by describing in detail exemplary embodiments thereof with reference to the attached drawings in which:

Hereinafter, exemplary embodiments of the present invention will be described in detail. However, the present invention is not limited to the exemplary embodiments disclosed below, but can be implemented in various types. Therefore, the present exemplary embodiments are provided for complete disclosure of the present invention and to fully inform the scope of the present invention to those ordinarily skilled in the art.

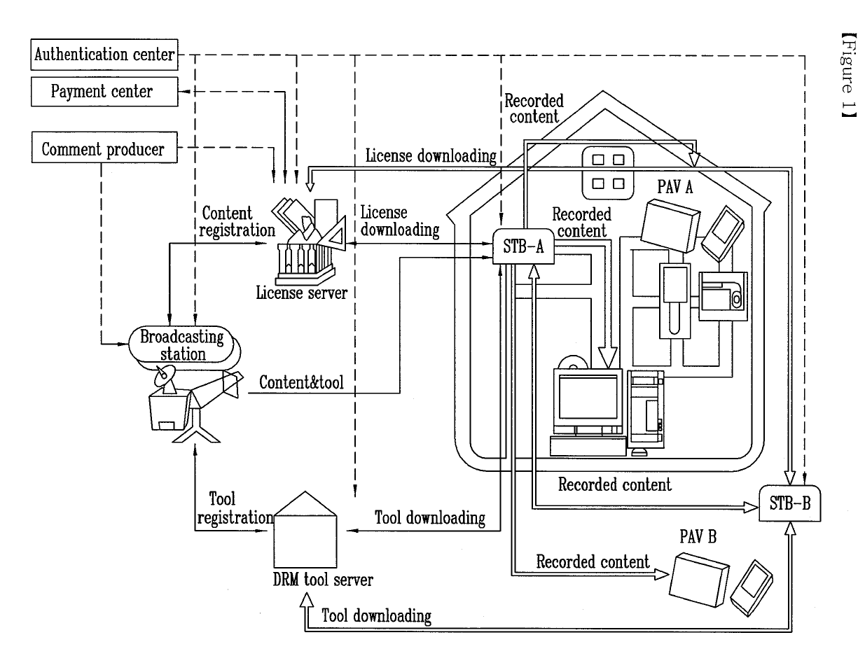

FIG. 1 shows transmission and distribution of broadcast content, transmission of a broadcast stream from a broadcast contents provider, utilization of the broadcast contents in a set-top box and a secondary subscriber terminal, and redistribution of the broadcast contents by a user.

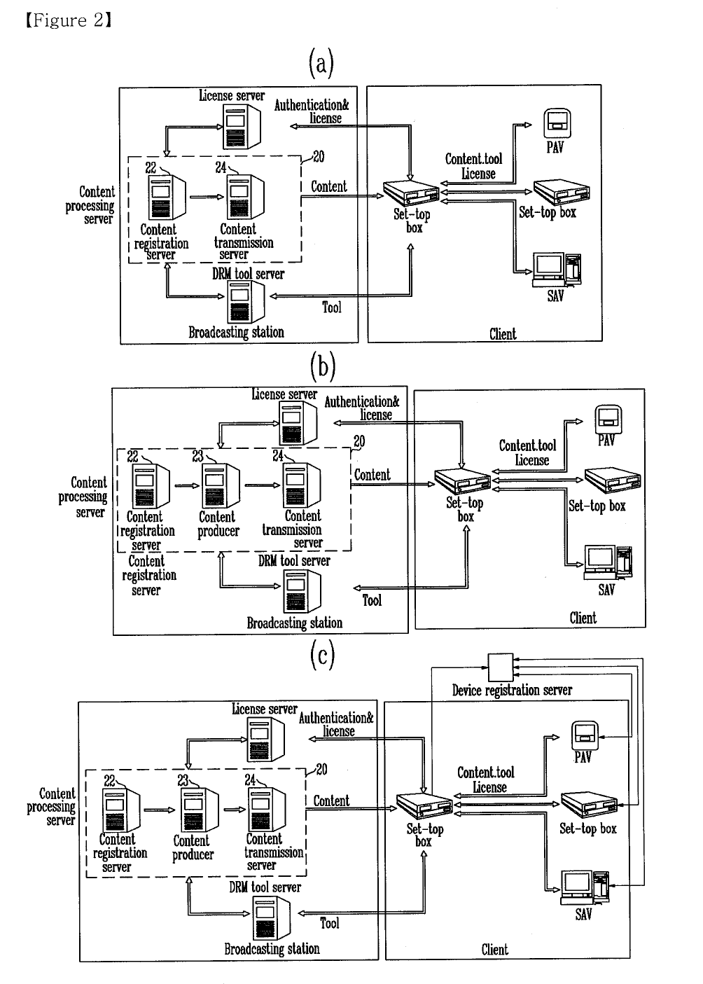

FIG. 2A is a schematic diagram of a broadcast contents protection and management system according to an exemplary embodiment of the present invention, focusing on servers which are the subjects of each operation. In the broadcast contents protection and management system of FIG. 2A, a contents processing server 20 is implemented by both a contents registration server 22 and a contents transmission server 24. The roles of the contents registration server 22 and the contents transmission server 24 may depend on the implementation of the overall digital contents broadcasting system including the contents protection and management system of the present invention. For example, when a broadcasting station company has only the contents transmission server 24, the contents provider has the contents registration server 22, and each contents provider has its own contents conversion format for protecting content, works related to a DRM tool server 40 can be performed in the contents registration server 22, and functionalities related to a license server 50 can be performed in the contents transmission server 24. On the other hand, when the contents transmission server 24 performs a function similar to a base station of each broadcasting station, works related to the DRM tool server 40 and the license server 50 can be performed only in the contents registration server 22, and the contents transmission server 24 performs a function for finally converting data into a standard broadcasting format.

In the later case, the contents provider may have a contents producer for producing broadcast contents from a broadcasting product using an appropriate tool. FIG. 2B is a block diagram of the broadcast contents protection and management system according to an exemplary embodiment of the present invention, focusing on the contents producer. In FIG. 2B, the contents producer 23 downloads a tool necessary for producing the broadcast contents from the DRM tool server 40 and produces the broadcast content, registers catalogue information (e.g., ID) about the produced broadcast contents with the license server 50, and uploads the produced broadcast contents to the contents registration server 22.

The contents protection and management system of the present invention may be implemented to be linked with a client domain (e.g., school domain) system. FIG. 2C is a block diagram of the contents protection and management system linked to the client domain according to the exemplary embodiment of the present invention.

The client domain comprises a client domain controller (e.g., set-top box) for accessing the contents processing server 20, the DRM tool server 40 and the license server 50. The broadcast contents received under control of the client domain controller is stored in a PVR, and the stored broadcast contents can be transmitted to another device within the same home or another set-top box at a different home.

Exemplary embodiments of the contents processing server 20 for producing information for protecting and managing the broadcast content, the DRM tool server 40 for managing various tools, and the license server 50 for managing a license, authentication, and payment, which are servers configuring the broadcast contents protection and management system, will be explained below in detail.

1. Contents Processing Server (Provider Server)

The contents processing server of the present invention comprises a contents registration module which registers the broadcast contents to be serviced to the license server 50 and receives information (e.g., contents ID, license server public key, license server URL, etc.) necessary for distribution of the broadcast content, a tool manage module for selecting a tool to be applied to the broadcast content, and a protected stream production module for encoding raw format data of the broadcast contents with the selected tool. The contents registration module, the tool manage module and the broadcast stream production module may be implemented by a hardware module contained in the contents registration server or by a software module performed in a central processing unit of the contents registration server.

The contents processing server may be implemented with the contents registration server 22, the contents producer 23, and the contents transmission server 24, as shown in FIG. 2B. Here, the contents registration module can comprise the contents producer 23, and the contents producer 23 uploads the broadcast contents produced by the tool downloaded from the DRM tool server 40 to the contents registration server 22 and registers the contents information in the license server 50. The contents producer 23 can upload the information (e.g., contents ID, license server public key, license server URL, etc.) necessary for distribution of the broadcast contents which is received from the license server 50 to the contents registration server 22 together with the corresponding broadcast contents when registering the broadcast content.

The contents registration server 22 is a server for storing the broadcast contents and producing protection and management information necessary for protecting and managing the broadcast content, and can be connected to the license server 50 and the DRM tool server 40 to transmit the protection and management information and the broadcast contents to the contents transmission server 24. Alternatively, the contents registration server 22 can register the broadcast contents information to the license server 50 without passing through the contents producer 23 and directly receive the information necessary for distribution of the broadcast contents (e.g., contents ID, license server public key, license server URL, etc.). At the state of registration in the contents registration server 22, a tool can be selected for the broadcast contents. Here, when the tool to be applied is not stored in the DRM tool server 40, the contents registration server 22 can register a new tool and a tool descriptor to the DRM tool server 40.

The contents transmission server 24 transmits the protected stream received from the contents registration server 22 or the contents producer 23 to a subscriber terminal (e.g., set-top box). At this time, the broadcast stream can be converted to a prescribed format before transmission, and conversion to the prescribed format can be performed by the tool registered in the DRM tool server 40. In this case, the contents transmission server 24 can receive the tool directly from the DRM tool server 40 or indirectly through the contents registration server 22. In the later case, the contents registration server 22 transmits the information for distribution, information on the tool, and information for storage in the form of a syntax file, and at the same time, transmits information for the tool to be applied in the contents transmission server 24 in the form of a discrete syntax file.

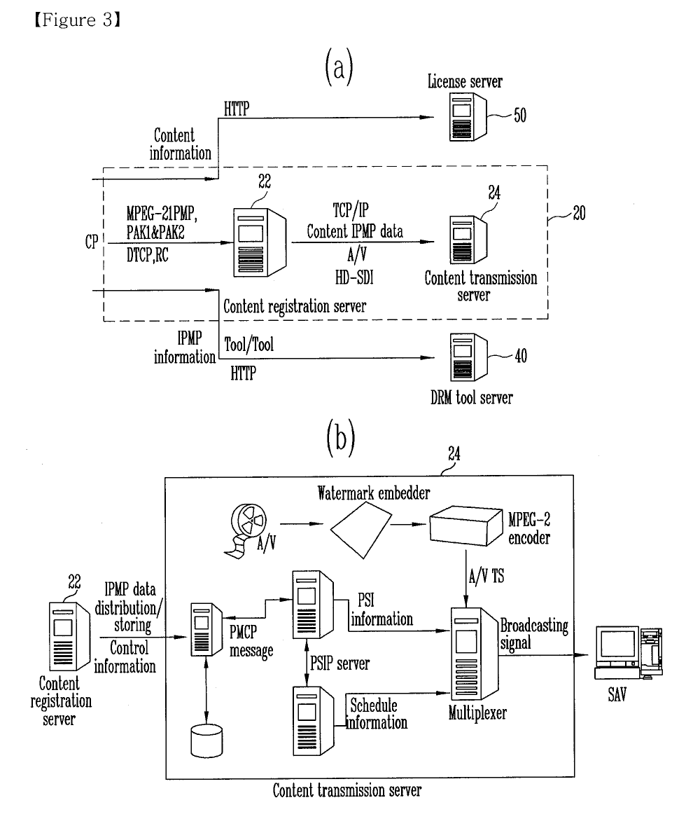

Referring to FIG. 3A, when data is compressed by an MPEG-2 technique and then transmitted, the contents processing server 20 can comprise an MPEG-2 encoder (software or hardware) for encoding A/V data of a low format, and the A/V encoded stream (ES) encoded by the MPEG-2 encoder is multiplexed with the protection and management information and then finally output as the protected stream. At this time, the A/V encoded stream (ES) can be multiplexed with watermark information and/or metadata for broadcast contents protection and management together. In this case, the contents transmission server 24, as shown in FIG. 3B, can comprise a watermark embedder.

The contents processing server 20 can further comprise a tool download function. The contents processing server 20 is required to have a corresponding tool in order to to produce the ES and/or protected stream. Here, a default watermark insertion and encryption tool can be embedded in the contents processing server 20, and a new tool can be applied at the discretion of the contents provider. In this case, the new tool can be downloaded from the DRM tool server 40. Content management and protection (IPMP) information received from the contents registration server 22 can be revised according to a tool to be applied within the contents transmission server 24.

Meanwhile, for the sake of broadcasting service management, usage information which contains information related to use of the broadcast contents in the subscriber terminal such as recording information, a storing method, and redistribution, and subscriber information which contains information indicating a subscriber's right, an expiration term and etc. may need to be managed. Both the usage information and the subscriber information can be managed in the contents registration server 22 or the contents transmission server 24. Alternatively, the usage information can be managed in the contents registration server 22, and the subscriber information can be managed in the contents transmission server 24.

2. DRM Tool Server

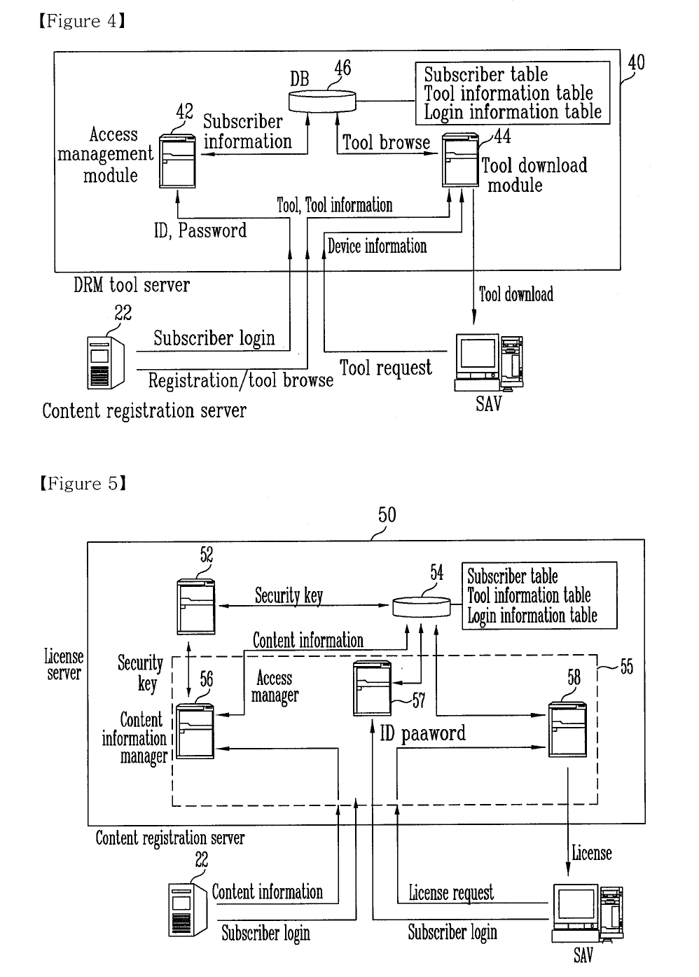

The DRM tool server 40 of FIG. 4 is a server which manages tools for the broadcast content, such as an encryption/decryption tool, a scrambling/descrambling tool and/or a watermark/fingerprinting tool for the broadcast content.

As shown in FIG. 4, the DRM tool server 40 comprises a tool database 46 for storing the tools and tool information, an access management module 42 for managing access to the contents registration server 22, and a tool download module 44 for downloading tools necessary for playing the broadcast contents to each subscriber terminal.

The contents provider registers tools and tool information such as a tool ID list in the DRM tool server 40 for the contents registration server 22 and contents producting module. Then, the contents registration server 22 processes the stored contents data using the tools registered in the DRM tool server 40 and transmits the processed contents data to the subscriber terminal through the contents transmission server 24. The contents user or customer executes (e.g., watchs or records) the broadcast contents in his/her multimedia device (i.e., subscriber terminal). At this time, the tools for processing the broadcast contents can be downloaded from the DRM tool server 40.

The tools used by the contents registration server 22 or user devices can be managed as a type of tool group or tool pack which include tools and tool agent together. In this case, the DRM tool server 40 can issue certificates for a tool, a tool list, and a tool agent, manage them as one tool pack, and assigns the tool pack a tool pack ID.

In more detail, the tool/tool pack is registered through the authentication procedure of the DRM tool server 40, and the subscriber (End-User) can download only the authenticated tools. The tool/tool pack stored in the DRM tool server 40 can be downloaded by a broadcasting terminal, a stationary terminal and the contents transmission server 24. The contents transmission server 24 can apply the tool before multiplexing the broadcast content, which follows a policy of the broadcast contents provider. The tool/tool pack stored in the DRM tool server 40 can be managed in the form of a database.

3. License Server (Clearing House)

The license server 50 of FIG. 5 is in charge of functions for issuing a license which contains a right of use and conditions for control and distribution of the broadcast contents by the subscriber, and functions for accounting, payment management and authentication of subscriber, device, content, and domain.

To this end, the license server 50 may comprise a key management module 52, an authentication data storage module 54, and an authentication module 55.

The key management module 52 is used to store the contents information and license key information in the form of a hidden protected packet in the data storage of the license server 50. The authentication module 55 requests the key information to the key management module 52 when using and processing the corresponding contents information.

The authentication data storage module 54 comprises a contents information table, a subscriber information table, and a license information table. The contents information table stores the catalogue information input from the contents registration server. The subscriber information table can store the login information of the contents provider which accesses the license server 50 through the contents registration server 22 and the login information of the contents customer who accesses the license server through the client domain controller. The license information table includes the information necessary for issuing the license to each subscriber.

The authentication module 55 comprises a contents information manager 56, an access manager 57, and a license issuer 56. The contents information manager 56 is requested to register the contents information from the contents registration server 22 and stores the contents information in the authentication data storage module. The contents information may be encrypted before being stored. In this case, the necessary key is managed by the management module 52.

The access manager 57 check certification of the contents provider which logs in through the contents registration server 22 and the certification of the customer which logs in through the client domain controller. Here, the contents customer is identical to the broadcasting service subscriber from the contents registration server 22's viewpoint, but since the contents registration server 22 and the license server 50 may perform different discrete procedures, it is given a different term from the subscriber.

The license issuer 58 can issues a license specified by corresponding contents and a corresponding contents customer, at the contents customer's request, for issuing the license to verify the right of use of the broadcast contents to be executed.

The broadcast contents protection and management system of the present invention can be embodied to be linked with each client domain system having a plurality of contents executing devices and/or a plurality of subscribers. In this case, the authentication data storage module of the license server can store information about devices and subscribers contained in each client domain, and the authentication module can perform a procedure for registering the devices and/or subscribers contained in each client domain system.

The client domain system will be explained below in detail.

The subscriber terminal is a basic element for configuring the client domain, and a home domain is comprised of a single set-top box, various devices within a home connectable to the set-top box, and subscriber group. The client domain, which is a customer site for the contents data, should have at least one subscriber terminal.

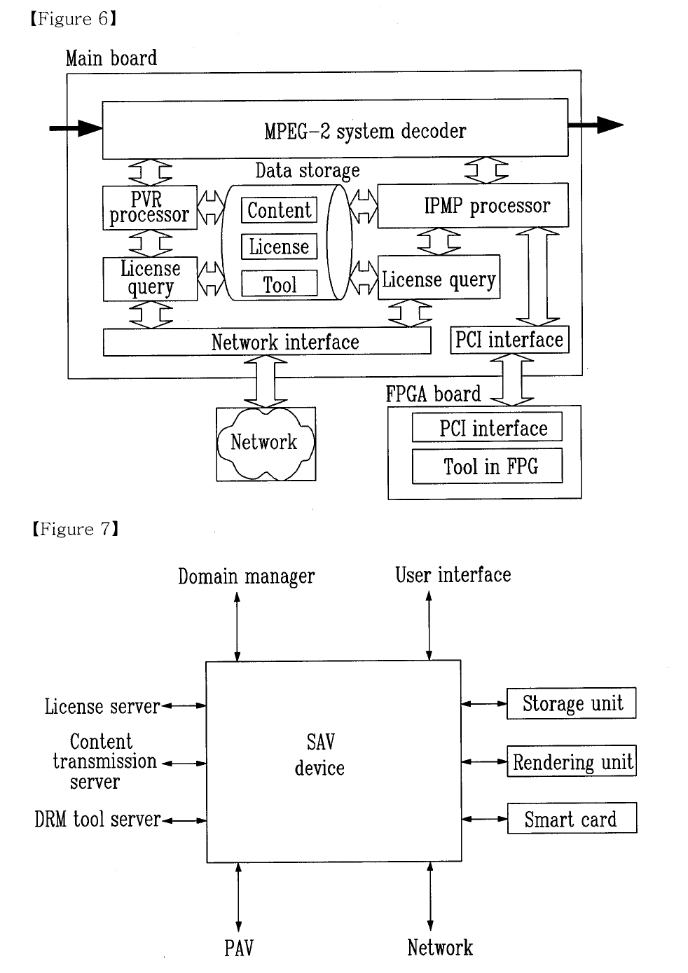

FIG. 6 a block diagram of the subscriber terminal according to an exemplary embodiment of the present invention. In the subscriber terminal of FIG. 6, the content transmitted from the contents transmission server enters a demultiplexer after passing through a tuner. During the procedure, as shown in FIG. 6, information for protecting and managing the contents is parsed so that the broadcast contents is stored or watched. The stored contents is protected and managed in the portable/stationary terminal as well as the broadcasting terminal as the subscriber terminal. And the subscriber terminal downloads the tool applied to the contents from the tool server, and accesses the license server to be issued with the license or to get the right to use the contents.

As the subscriber terminal of FIG. 6, a stationary audio and video (SAV) device and a portable audio and video (PAV) device are provided. As the SAV device, a set-top box which receives the broadcast contents is provided. The subscriber terminal can have the follow functions:
various IPMP tools: various encryption, watermarking algorithms, etc.;
real-time AV watermarking detection: function for detecting an AV watermark during contents reproduction;
IPMP tool update: IPMP tool download for contents reproduction (from DRM tool server);
contents storage control: permission to store contents within subscriber terminal;
usage control by license;
packaging in subscriber terminal: contents encryption hiding for protection of stored content; and
license acquisition and management: license purchase and management for contents management.

FIG. 7 is a block diagram of the subscriber terminal (SAV device) according to an exemplary embodiment of the present invention depicted focusing on the servers and an interface.

The SAV device of FIG. 7 comprises a provider interface module for providing a data communication channel with the broadcasting station to receive the broadcast contents and the tool and license required for execution of the broadcast content, and a client domain interface module for providing a user interface and a communication channel with other multimedia devices. The SAV device can further comprise a storage unit for storing the broadcast content, a rendering unit for playing the broadcast content, and an authentication unit for performing authentication for a server of the broadcasting station side.

The provider interface module may comprise a license interface module for accessing the license server to get the license for the broadcast content, a contents interface module for accessing the contents transmission server to receive the broadcast content, and a tool interface module for accessing the DRM tool server to download the tool necessary for executing the broadcast content.

The client domain interface module may comprise a user interface module for notifying the subscriber of an internal status and receiving commands from the subscriber, a domain manager interface module for accessing a domain manager for managing the prescribed client domain, a network interface module for accessing a network which forms the client domain, and a portable interface module for accessing a portable multimedia device.

Operation of the SAV device will be explained below.

When a license is expired, the SAV device accesses the license server which has issued the license and requests reissuing of the license,. Also, the SAV device can download a latest version of the DRM tool updated by the broadcasting company from the DRM tool server to thereby renew the DRM tool.

Here, let us define a contents file to which a DMP is applied as a DMP contents file (DCF). The SAV device receives the DCF from the contents provider server and can redistribute the DCF to another multimedia device such as the SAV and PAV devices. When the DCF is redistributed, a bundle license for the DCF redistributed by the source SAV device can be issued. When the bundle license is issued, the source SAV device can encrypt the resource contained in the DCF to be redistributed with an appropriate DRM tool. Meanwhile, when a broadcast content is redistributed to the PAV device, the SAV device can perform a procedure for converting the broadcast contents to redistributable format for the PAV device. A tool necessary for issue of the bundle license, a tool necessary for conversion of the broadcast content, and/or a tool necessary for the resource encryption can be downloaded from the DRM tool server.

Here, “redistribution” represents a copy of the DCF which means that the source SAV device continuously retains the redistributed DCF or a move of the DCF which means that the source SAV device deletes the redistributed DCF. The DCF can contain DMP contents information (DCI) which indicates a DRM tool necessary for executing the DCF.

The DCF is executed by the SAV device as follows. The SAV device which has received the DCF parses the DCF to get a license and a DCI, parses the DCI to perceive a tool necessary for executing the broadcast content, and perceives a right granted for use of the broadcast content. Then, the SAV device parses the license to obtain a security key necessary for decrypting the resource contained in the DCF. The SAV device obtains a means necessary for executing the broadcast contents and executes the broadcast contents through the rendering unit.

A procedure for the broadcasting service subscriber to receive the broadcast contents in the broadcast contents protection and management system will be explained.

When the subscriber wants a new channel service, the subscriber requests a desired channel service to the broadcasting station through his/her set-top box. The broadcasting station registers the subscriber's new service request and makes the subscriber's client domain controller (set-top box) download the protection tools necessary for watching the new service channel from the tool registration server. When the broadcasting station desires to apply a new protection tool to prescribed broadcast contents or a broadcasting channel which is currently on the air, the new protection tool can be inserted into the broadcast stream and then transmitted. Thus, the subscriber's set-top box can apply the new protection tool to watch the broadcast content.

When the subscriber desires to record the broadcast contents through the set-top box, recording the broadcast contents is controlled according to a contents protection policy of each broadcasting company. In a case where the subscriber desires to play the recorded broadcast content, the recorded broadcast contents are available only when it is stored through a distribution path specified by a distribution policy of each broadcasting company. In particular, premium contents are set to be recorded only after getting the license through the clearing center.

The broadcast contents recorded in the subscriber's set-top box can be moved to another device within the same client domain of the subscriber according to the subscriber's needs, and then can be reused in another device. Also, the broadcast contents can be redistributed to the client domain of another subscriber. In this case, a license for redistribution of the broadcast contents may be required.

While the invention has been shown and described with reference to certain exemplary embodiments thereof, it will be understood by those skilled in the art that various changes in form and details may be made therein without departing from the spirit and scope of the invention as defined by the appended claims.

1. A contents processing server arranged in a digital contents broadcasting service system in which a contents provider provides a subscriber terminal with digital content, the contents processing server comprising:
a contents producer for producing content;
a contents registration server for storing content; and
a contents transmission server for transmitting the contents to the subscriber terminal.

2. A contents processing server arranged in a digital contents broadcasting service system in which a contents provider provides a subscriber terminal with digital content, the contents processing server comprising:
a contents registration module for registering contents to be serviced to a license server and receiving information necessary for a contents service;
a tool manage module for selecting a tool to be applied to the content; and
a protected stream producing module for encoding data of a low format for the contents using the selected tool.

3. A DRM tool server arranged in a digital contents broadcasting service system in which a contents provider provides a subscriber terminal with digital content, wherein the DRM tool server stores tools such as encryption, decryption, scrambling, descrambling ,watermarking and fingerprinting tools for the digital content, receives the tools from the contents provider, and downloads the requested tools to the subscriber terminal.

4. The DRM tool server of claim 3, comprising:
a tool database for storing the tools;
an access management module for managing access to the contents provider through an external contents processing server; and
a tool download module for downloading tools necessary for contents usage in the subscriber terminal.

5. A license server arranged in a digital contents broadcasting service system in which a contents provider provides a subscriber terminal with digital content, wherein the license server performs a function for issuing a license which contains a right of usage and condition for control and distribution of the content.

6. The license server of claim 5, further comprising:
a contents information manager for receiving a contents information registration request of the contents provider through an external contents processing server and storing the contents information registration request in an internal storage module;
an access manager for checking certification of the contents provider and/or of the subscriber; and
a license issuer for issuing a license for ensuring the subscriber's right to the content.

7. A SAV device, comprising:
a provider interface module for providing a data communication channel with a server of a broadcasting station to receive broadcast contents and a tool and license necessary for execution of the broadcast content; and
a client domain interface module for providing a user interface and a communication channel with other multimedia devices.

8. The SAV device of claim 7, wherein the provider interface module comprises:
a license interface module for accessing a license server of the broadcasting station to get a license for the broadcast content;
a contents interface module for accessing a contents transmission server to receive the broadcast content; and
a tool interface module for accessing a DRM tool server of the broadcasting station to download a tool necessary for executing the broadcast content.

9. The SAV device of claim 7, wherein the client domain interface module comprises:
a user interface module for notifying the subscriber of an internal status and receiving commands from the subscriber;
a domain manager interface module for accessing a domain manager for managing a prescribed client domain;
a network interface module for accessing a network which forms the client domain; and
a portable interface module for accessing a portable multimedia device.

10. The SAV device of claim 7, further comprising,
a storage unit for storing the content;
a rendering unit for reproducing the content; and
an authentication unit for performing authentication for the broadcasting server.

11. A contents protection and management system which is implemented in a digital contents broadcasting service system in which a contents provider provides a SAV device of a service subscriber with digital content, the contents protection and management system comprising:
a contents processing server for providing the service subscriber with contents and producing information for protection and management of the content;
a DRM tool server for managing tools used in the contents processing server and the subscriber terminal to process the content; and
a license server for managing the subscriber's right to the content.

12. The system of claim 11, wherein the contents processing server is the contents processing server stated in claim 1 or 2.

13. The system of claim 11, wherein the DRM tool server is the DRM tool server stated in claim 3 or 4.

14. The system of claim 11, wherein the license server is the license server stated in claim 5 or 6.

15. The system of claim 11, wherein the SAV device is the SAV device stated in any one of claims 7 to 10.
